(19) United States
(12) Patent Application Publication
(10) Pub. No.: US 2016/0048271 A1
(43) Pub. Date: Feb. 18, 2016

(54) INFORMATION PROCESSING DEVICE AND INFORMATION PROCESSING METHOD

(71) Applicant: SONY CORPORATION, Minato-ku, Tokyo (JP)

(72) Inventors: Katsuya HYODO, Kanagawa (JP); Takashi KITAO, Tokyo (JP); Kenichi YAMAURA, Kanagawa (JP); Nobuhiro JOGANO, Kanagawa (JP); Kazuto NISHIZAWA, Kanagawa (JP); Tatsuya HAMA, Tokyo (JP)

(73) Assignee: Sony Corporation, Minato-ku, Tokyo (JP)

(21) Appl. No.: 14/779,261

(22) PCT Filed: Feb. 5, 2014
(86) PCT No.: PCT/JP2014/052660

§ 371 Date: Sep. 22, 2015

(30) Foreign Application Priority Data
Mar. 29, 2013 (JP) 2013-071910

(51) Int. Cl. G06F 3/0482; G06F 3/0484

(52) U.S. Cl. CPC G06F 3/0482; G06F 3/04842

(57) ABSTRACT

[Object] To provide a method of enabling a user to select a desired playlist easily from among a plurality of playlists

[Solution] Provided is an information processing device including: a playlist acquisition unit configured to acquire a plurality of playlists each including content, and list evaluation information for each playlist; and a display control unit configured to cause a selection screen for selecting one playlist from among the acquired plurality of playlists to be displayed. On the selection screen, the display control unit adds a virtual object based on the list evaluation information for each playlist and causes the virtual object to be displayed.

### TECHNICAL FIELD

The present invention relates to an information processing device, and an information processing method.

### BACKGROUND ART

A known content reproducing device is a device that continuously reproduces a plurality of content items including sounds, still images, moving images, and the like, in accordance with a playlist that is created in advance. Here, the playlist is index information in which a plurality of content items that are to be continuously reproduced are arranged in the reproducing order, and the content items to be continuously reproduced typically have a certain continuity, relevancy, and the like.

In recent years, it has become difficult for a user to select a playlist that matches the user's preference because usable playlists are increased. In view of this point, the following Cited Literature 1 discloses a technique of switching from a content item in a certain playlist to another playlist when the other playlist includes the same content as the content included in the certain playlist.

### CITATION LIST

### Patent Literature

Patent Literature 1: JP4577438B

### SUMMARY OF INVENTION

### Technical Problem

With the above technique, however, a desired playlist cannot be selected easily from among a plurality of playlists. For example, when the playlist can be switched to a plurality of candidates, the user would not know which playlist to be selected, for example.

Accordingly, the present disclosure proposes a method of enabling a user to select a desired playlist easily from among a plurality of playlists.

### Solution to Problem

According to the present disclosure, there is provided an information processing device including: a playlist acquisition unit configured to acquire a plurality of playlists each including content, and list evaluation information for each playlist; and a display control unit configured to cause a selection screen for selecting one playlist from among the acquired plurality of playlists to be displayed. On the selection screen, the display control unit adds a virtual object based on the list evaluation information for each playlist and causes the virtual object to be displayed.

According to the present disclosure, there is provided an information processing method including: acquiring a plurality of playlists each including content, and list evaluation information for each playlist; and adding, when a selection screen for selecting one playlist from among the acquired plurality of playlists is displayed, a virtual object based on the list evaluation information for each playlist and causing the virtual object to be displayed.

### Advantageous Effects of Invention

As described above, according to the present disclosure, it becomes possible to enable a user to select a desired playlist easily from among a plurality of playlists.

### BRIEF DESCRIPTION OF DRAWINGS

FIG. 1 is a block diagram illustrating an example configuration of a playlist reproduction system 1 according to an embodiment of the present disclosure.

FIG. 2 is a diagram illustrating an example of a playlist selection screen 700 according to an embodiment.

FIG. 3 is a diagram illustrating an example of a display configuration of a playlist PL1.

FIG. 4 is a diagram for describing an example of animation of a virtual object added to the playlist PL1.

FIG. 5 is a diagram illustrating an example of an outline screen 720 of the playlist PL1 according to an embodiment.

FIG. 6 is a diagram illustrating an example of a playlist reproduction screen 730 according to an embodiment.

FIG. 7 is a diagram illustrating an example of reproduction of content on the playlist reproduction screen 730.

FIG. 8 is a diagram for describing the playlist reproduction screen 730.

FIG. 9 is a diagram illustrating an example virtual object displayed on the playlist reproduction screen 730.

FIG. 10 is a diagram illustrating examples of related content and virtual objects.

FIG. 11 is a diagram illustrating examples of virtual objects at a branch of a railroad track.

FIG. 12 is a diagram illustrating a display example of a comment about a playlist.

FIG. 13 is a diagram illustrating an example of a comment registering screen.

FIG. 14 is a flowchart illustrating reproduction processing of a playlist according to an embodiment.

FIG. 15 is an explanatory diagram illustrating a hardware configuration of an information processing device 100.

### DESCRIPTION OF EMBODIMENTS

Hereinafter, preferred embodiments of the present disclosure will be described in detail with reference to the appended drawings. Note that, in this specification and the drawings, structural elements that have substantially the same function and structure are denoted with the same reference signs, and repeated explanation is omitted.

Note that the description will be made in the following order.

1. Outline of Playlist Reproduction System

2. Configuration of Information Processing Device

3. Reproduction Processing of Playlist

4. Hardware Configuration

5. Conclusion

### 1. Outline of Playlist Reproduction System

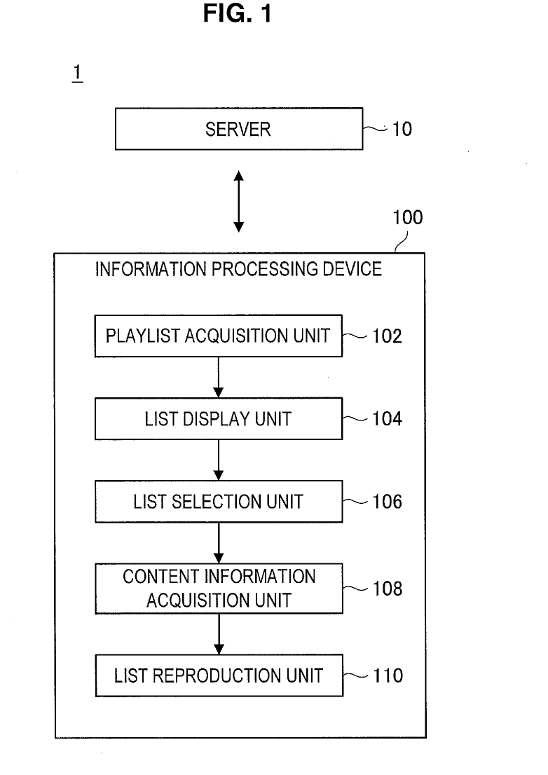

An outline of a playlist reproduction system according to an embodiment of the present disclosure will be described with reference to FIG. 1.

FIG. 1 is a block diagram illustrating an example configuration of a playlist reproduction system 1 according to an embodiment of the present disclosure. The playlist reproduction system 1 is a system that acquires, from a server, a playlist that is created in advance, the playlist including a plurality of content items, and reproduces the acquired playlist. The playlist reproduction system 1 includes a server 10 and an information processing device 100, as illustrated in FIG. 1.

The server 10 transmits or receives data to or from the information processing device 100 via a network. The server 10 stores data of a playlist including a plurality of kinds of content items and content data included in the playlist, and transmits such data to the information processing device 100 in response to a request made by the information processing device 100.

The information processing device 100 is a device that acquires the playlist from the server 10 via the network and reproduces the acquired playlist. The information processing device 100 is, for example, a device that can reproduce content, such as a laptop computer, a tablet, or a mobile phone. A detailed structure of the information processing device 100 will be described later.

Note that the playlist is index information in which a plurality of content items that are to be continuously reproduced are arranged in the reproducing order. The playlist is created by arranging the plurality of content items so that the content items to be continuously reproduced can have a certain continuity, relevancy, and the like. Here, the continuity or relevancy among the content items means, for example, that the content items have the same or similar musical characteristics (tempo, melody, etc. of musical compositions) or the same or similar musical impression to audience (brightness, intensity, etc.), in a case of audio content.

### 2. Configuration of Information Processing Device

An example functional configuration of the information processing device 100 will be described with reference to FIG. 1. As illustrated in FIG. 1, the information processing device 100 includes a playlist acquisition unit 102, a list display unit 104 being an example of a display control unit, a list selection unit 106, a content information acquisition unit 108, and a list reproduction unit 110 being an example of a reproduction unit.

### Playlist Acquisition Unit 102

The playlist acquisition unit 102 acquires playlist data from the server 10. For example, the playlist acquisition unit 102 requests playlist data from the server 10 when an application is started. The playlist acquisition unit 102 outputs the acquired playlist data to the list display unit 104.

Here, the acquired playlist data includes, for each playlist, ID, title, time, description, content ID, first evaluation of the playlist, second evaluation of the playlist, and virtual object information, for example. Note that, in the present embodiment, the first evaluation of the playlist and the second evaluation of the playlist correspond to list evaluation information.

The ID is unique information for identifying the playlist. The title is text information used as the title of the playlist. The time is text information representing the length (time) of the playlist. The description is text information describing the content of the playlist. The content ID is arrangement of IDs of content data included in the playlist. The first evaluation of the playlist is evaluation information representing expressions of persons who have seen the playlist. The second evaluation of the playlist is information on the number of persons who liked the playlist (the number of “Like”s). The virtual object information is arrangement obtained by combining comment text about the playlist, display timing (seconds from the start of reproduction), and the expression of a virtual object (a so-called avatar). Note that, as the expressions of virtual objects, for example, crying, laughing, expressionless, smiling, and surprised are allocated.

In this manner, the playlist acquisition unit 102 acquires a plurality of playlists including a plurality of content items of different kinds and list evaluation information for each playlist. Note that the playlist acquisition unit 102 acquires a plurality of pieces of list evaluation information for each playlist. That is, evaluation information of a plurality of persons is acquired.

### List Display Unit 104

The list display unit 104 causes a list screen of a plurality of playlists to be displayed on the basis of the playlist data acquired from the server 10. Here, the list screen is a selection screen on which the user can select one playlist from among the plurality of playlists.

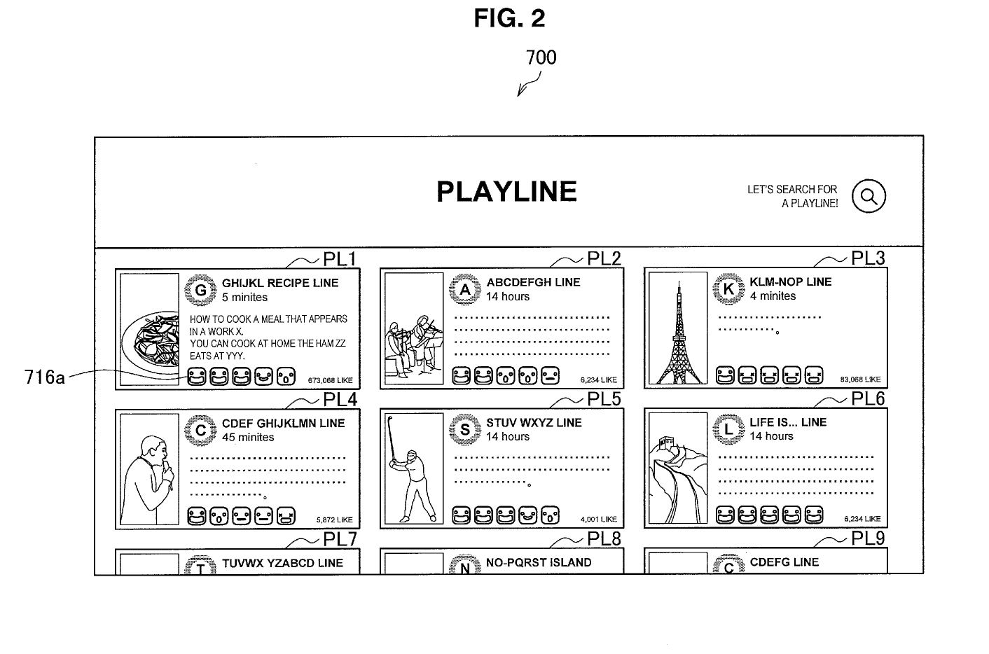

FIG. 2 is a diagram illustrating an example of a playlist selection screen 700 according to an embodiment. As illustrated in FIG. 2, on the selection screen 700, a plurality of playlists PL1 to PL9 are lined up and displayed. Since the playlists PL1 to PL9 have the same display configuration, the following description is made by taking the playlist PL1 as an example.

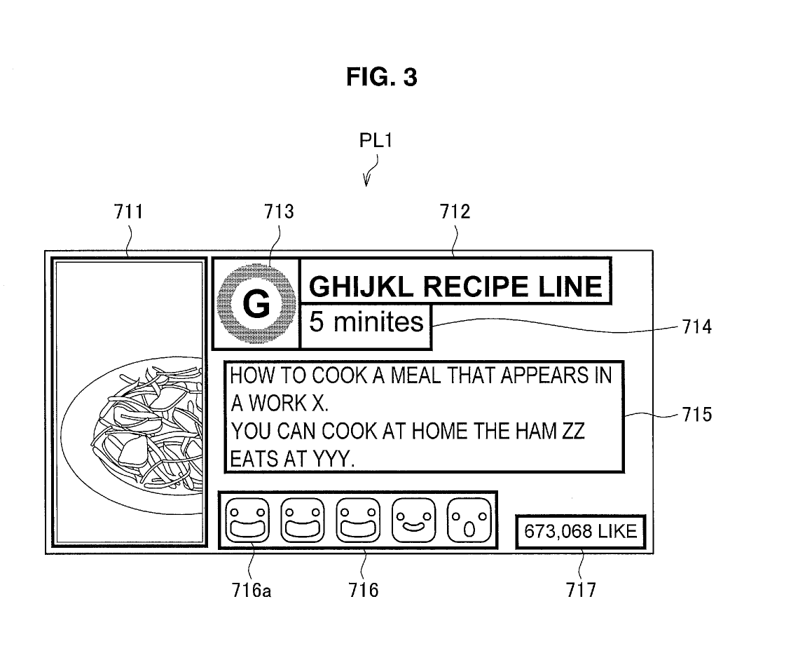

FIG. 3 is a diagram illustrating an example of a display configuration of the playlist PL1. As illustrated in FIG. 3, the playlist PL1 includes, for example, a thumbnail image 711, a title 712, a first letter 713 of the title, a time 714, a description 715, a first evaluation 716, and a second evaluation 717.

The thumbnail image 711 is a thumbnail image of content included in the playlist PL1. The title 712 indicates the title of the playlist PL1. The first letter 713 of the title indicates a first letter of the title of the playlist PL1. The time 714 indicates the length (reproduction time) of the playlist PL1. The description 715 indicates the content of the playlist PL1. The first evaluation 716 indicates virtual objects 716a representing expressions of persons who have seen the playlist PL1. The second evaluation 717 indicates the number of “Like”s of persons who liked the playlist PL1.

As illustrated in FIG. 2, the list display unit 104 adds, on the selection screen 700, the virtual objects 716a based on list evaluation information for each playlist, and causes the virtual objects 716a to be displayed. At this time, the list display unit 104 adds, to each playlist, the plurality of virtual objects 716a based on a plurality of pieces of list evaluation information and causes the plurality of virtual objects 716a to be displayed.

Further, the list display unit 104 causes the virtual objects 716a having a plurality of display modes on the basis of the list evaluation information to be displayed. Specifically, as illustrated in FIG. 3, the virtual objects 716a having a plurality of expressions (crying, laughing, expressionless, smiling, surprised) are displayed. Thus, the user can visually grasp other people's evaluation of the playlist PL1 by seeing the plurality of expressions of the virtual objects.

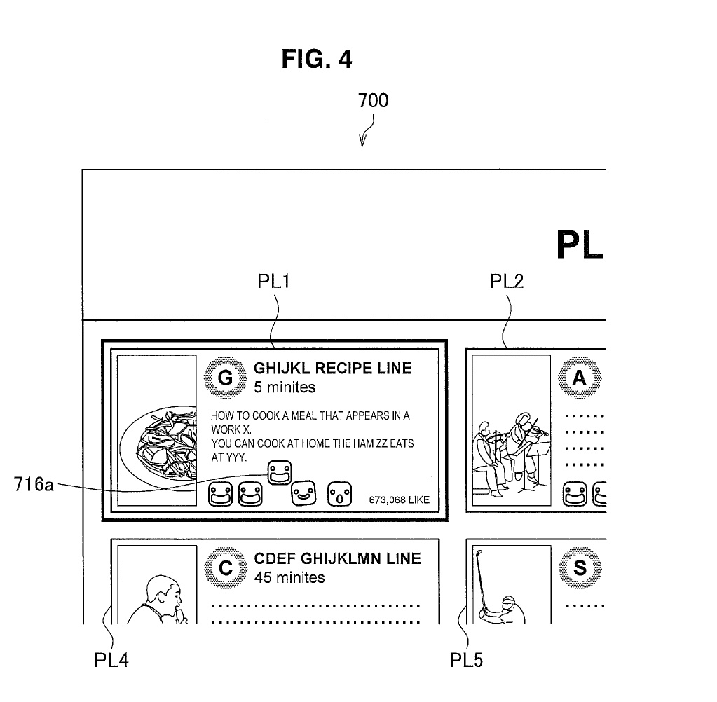

FIG. 4 is a diagram for describing an example of animation of a virtual object added to the playlist PL1. Here, on the selection screen 700, the playlist L1 is assumed to be in a temporarily selected state (a so-called mouse-hover state). Then, the list display unit 104 displays animation of the virtual objects 716a. Specifically, as illustrated in FIG. 4, the list display unit 104 moves the virtual objects 716a in the vertical direction (jump) and the horizontal direction (swing) at random. In this manner, in a case where one of the playlists is selected on the selection screen 700, the list display unit 104 causes display modes of the virtual objects 716a added to the one playlist to be changed.

### List Selection Unit 106

When the user decides selection of one playlist on the selection screen 700 (FIG. 2), the list selection unit 106 accepts the selection of the one playlist. Then, on the basis of playlist data, the list selection unit 106 causes an outline screen indicating an outline of the one playlist to be displayed. The following description is made on the assumption that the selection of the playlist PL1 is decided.

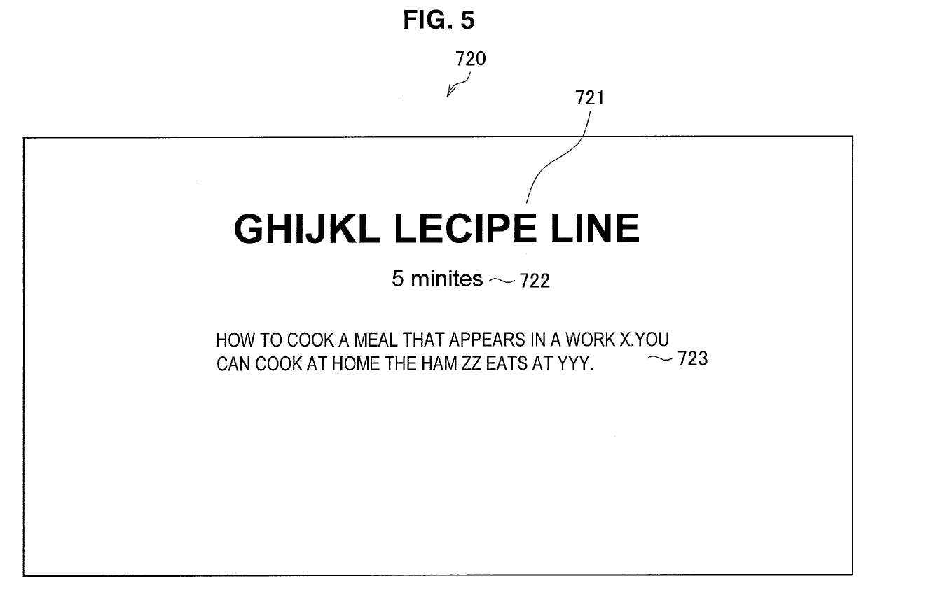

FIG. 5 is a diagram illustrating an example of an outline screen 720 of the playlist PL1 according to an embodiment. As illustrated in FIG. 5, the outline screen 720 of the playlist PL1 includes a title 721 of the playlist PL1, a reproduction time 722, and a description 723 of the playlist PL1. Thus, the user can grasp the outline of the playlist PL1 before reproducing the playlist PL1.

### Content Information Acquisition Unit 108

The content information acquisition unit 108 acquires, from the server 10, a plurality of pieces of content data included in the one playlist selected on the selection screen 700. For example, the content information acquisition unit 108 requests content data included in the playlist PL1 from the server 10, and acquires the content data, while the outline screen 720 of the playlist PL1 is being displayed. Note that the content information acquisition unit 108 may request content items in the order of reproduction on the basis of the content ID included in the playlist data. This can advance the start of reproduction of content.

Here, the content data acquired from the server includes content title, content composer, content type, content URL, URL of content BGM, reproduction time, virtual object information, and related content information.

The content title is text information displayed as the title of content. The content composer is text information displayed as the composer of content. The content type is information indicating the type of content. The content URL is information indicating the URL from which the content can be acquired. The URL of content BGM is information indicating the URL of the BGM reproduced while the content is being displayed. The reproduction time indicates the length (e.g., seconds) of content. The virtual object information is arrangement obtained by combining comment text about the content, display timing (seconds from the start of reproduction), and the expression of a virtual object. The related content information is information (e.g., information indicating the display position (seconds from the start of reproduction) or arrangement of the content IDs)) of content related to the reproduced content.

In the present embodiment, as the content type, video, music, image, Web page, or book may be set. In addition, as for content that does not include music in itself (image, Web page, book), the URL of BGM may be set.

In this manner, the content information acquisition unit 108 acquires content evaluation information of each content item in the one playlist to be reproduced. The content information acquisition unit 108 also acquires related content that relates to the content to be reproduced and content evaluation information of related content. The related content will be described later.

### List Reproduction Unit 110

When one playlist is selected on the playlist selection screen 700, the list reproduction unit 110 reproduces the one selected playlist. At this time, the list reproduction unit 110 causes the playlist to be reproduced on the basis of the acquired content data and playlist data.

In the present embodiment, when reproducing the one playlist, the list reproduction unit 110 adds a virtual object based on the content evaluation information and causes the virtual object to be displayed. Thus, the user can grasp other people's evaluation of the playlist or content by seeing the displayed virtual object.

When sequentially reproducing a plurality of content items included in the one playlist, the list reproduction unit 110 adds a comment to a virtual object corresponding to the content being reproduced, and causes the comment to be displayed. Thus, the user can properly grasp other people's evaluation of the content being reproduced, by reading the comment.

In addition, when reproducing the one playlist, the list reproduction unit 110 adds a virtual object based on the content evaluation information of related content and causes the virtual object to be displayed. Thus, the user can visually grasp other people's evaluation of the related content, by use of the virtual object indicating the evaluation of the related content. As a result, the user may select related content that matches the user's preference.

Further, when reproducing the one playlist, the list reproduction unit 110 causes another playlist to be displayed in a selectable manner and also adds a virtual object based on the list evaluation information of the other playlist and causes the virtual object to be displayed. Thus, the user can visually grasp other people's evaluation of the other playlist while the one playlist is being reproduced. As a result, the user can easily select the other playlist to be reproduced.

### Example of Reproduction of Playlist

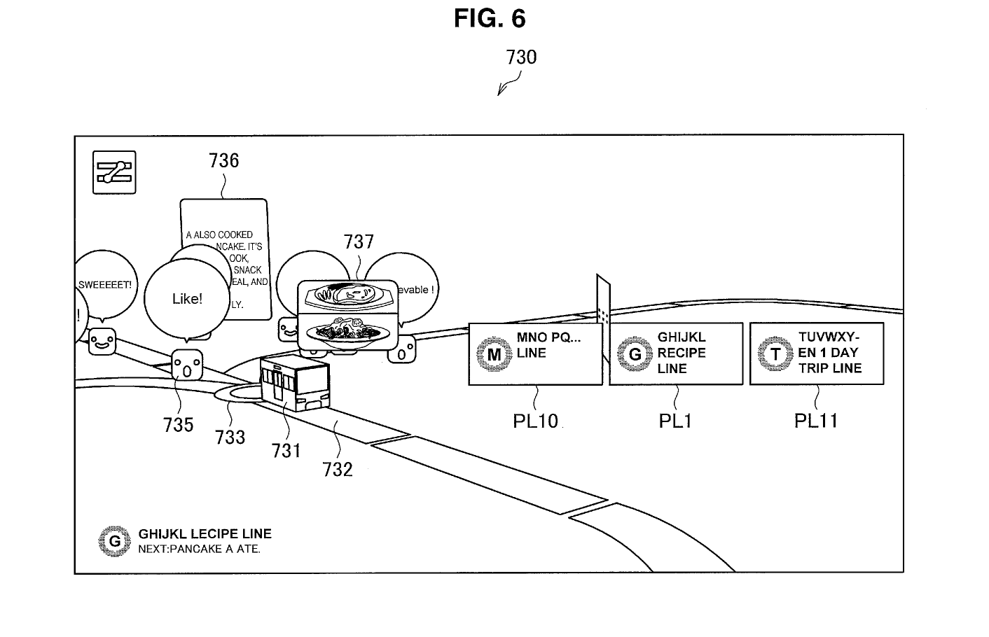

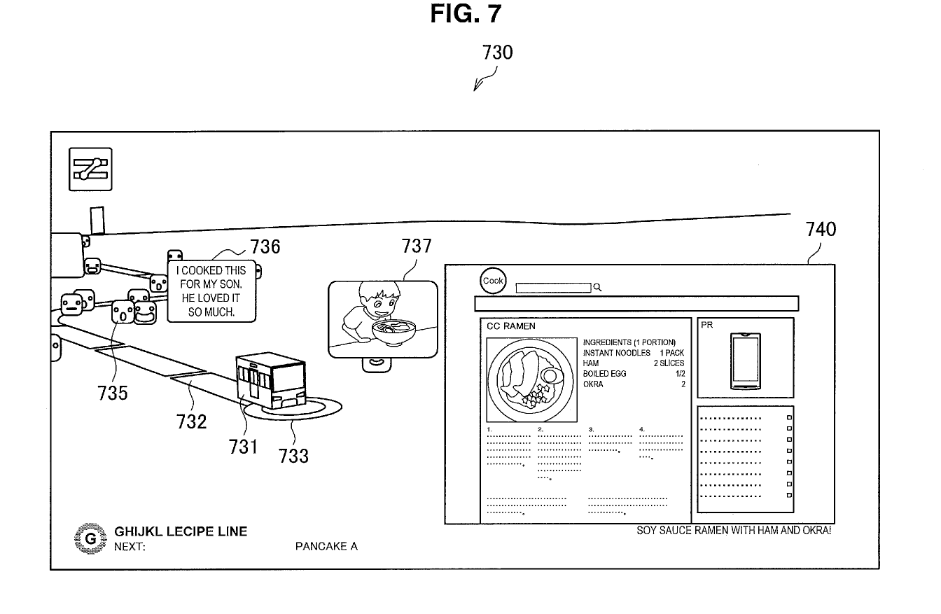

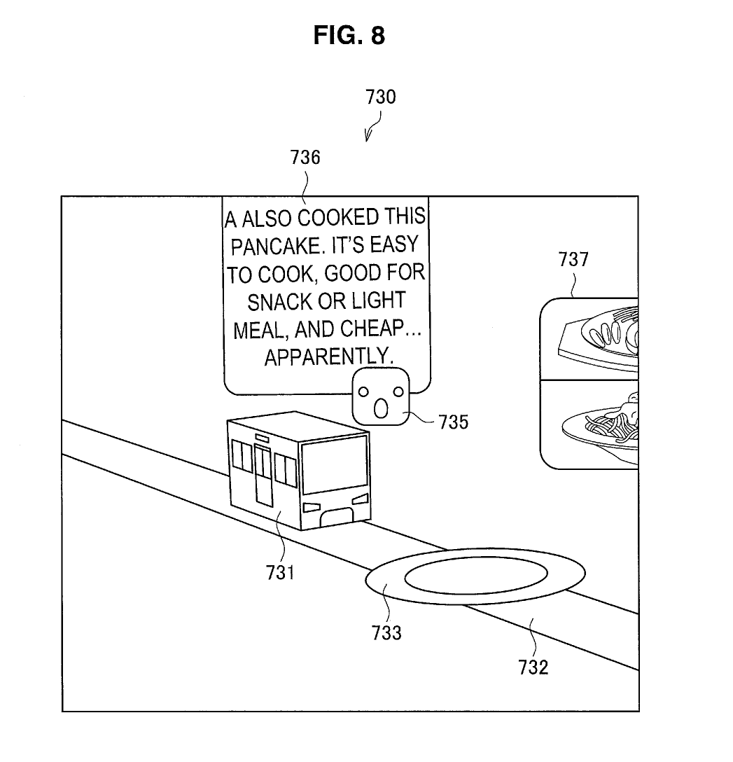

A specific example of reproduction of the playlist will be described with reference to FIG. 6 to FIG. 13. FIG. 6 is a diagram illustrating an example of a playlist reproduction screen 730 according to an embodiment. FIG. 7 is a diagram illustrating an example of reproduction of content on the playlist reproduction screen 730. FIG. 8 is a diagram for describing the playlist reproduction screen 730. The following description is made by taking the playlist PL1 as an example.

In the present embodiment, as illustrated in FIG. 6, on the reproduction screen 730 of the one playlist PL1, configuration is made so that other playlists PL10 and PL11 can be selected. Thus, the user can continuously reproduce a series of playlists having a strong relevancy and continuity with each other.

The list reproduction unit 110 performs reproduction by switching a program to be used in accordance with the type of content to be reproduced. As for content that does not include sounds (image, Web page, book), the list reproduction unit 110 reproduces a music file specified by the URL of the content BGM in background.

The reproduction time and reproduction position on the playlist reproduction screen 730 are indicated by a train 731, a railroad track 732, and a station 733, which are illustrated in FIG. 8. The train 731 moves along the railroad track 732, and passes through the station 733 or branches at the station 733. By branching at the station 733, movement is made to another playlist (e.g., the playlist PL10 or PL11 illustrated in FIG. 6). When reproducing the playlist, the train 731 moves on the railroad track 732, during which content is reproduced on a screen 740, as illustrated in FIG. 7.

On the playlist reproduction screen 730, the distance between a station 733 and the next station 733 (railroad track 732) represents the length of content. The current reproduction position is indicated by the position of the train 731 between stations 733. Note that the length of the railroad track 732 between stations 733 is set in accordance with the reproduction time of content information. In addition, a curve of the railroad track 732 or the like is automatically generated at random.

On the basis of the virtual object information included in content data, the list reproduction unit 110 causes a virtual object 735 representing a comment or expression to the content (FIG. 6) to be displayed. Here, the list reproduction unit 110 changes the display position, expression, and comment of the virtual object 735 depending on the virtual object information. Note that the list reproduction unit 110 causes the comment of the virtual object 735 that the train 731 approaches, to be displayed.

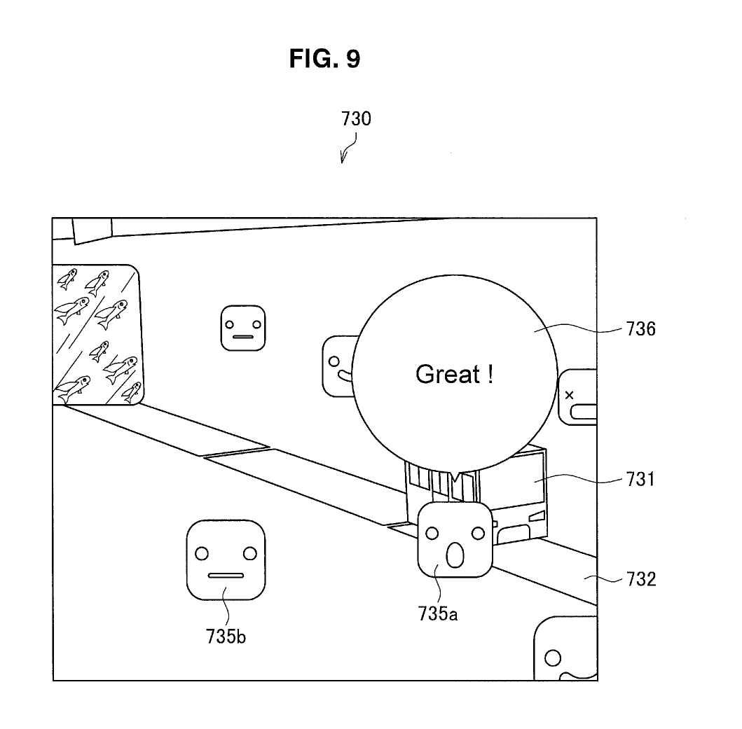

FIG. 9 is a diagram illustrating an example virtual object displayed on the playlist reproduction screen 730. In a case where information of expression and comment is present, the list reproduction unit 110 causes a virtual object 735a having expression and a comment 736 to be displayed, as illustrated in FIG. 9. In a case where information of comment is not present, the list reproduction unit 110 causes a virtual object 735b representing only the expression to be displayed.

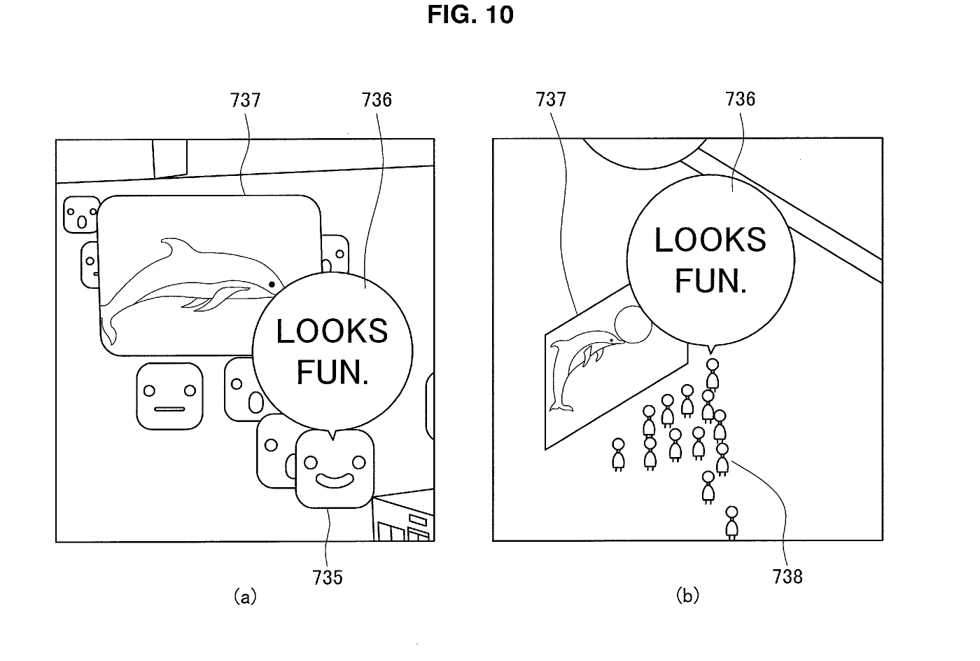

FIG. 10 is a diagram illustrating examples of related content and virtual objects. As illustrated in FIG. 10(a), the list reproduction unit 110 displays related content 737 that relates to content being reproduced and the virtual object 735 with respect to the related content. Here, the list reproduction unit 110 changes the display position, expression, and a comment 736 of the virtual object 735 depending on the virtual object information of the related content 737. Note that, in FIG. 10(b), as another display mode, a virtual object 738 gathering in front of the related content 737 is illustrated.

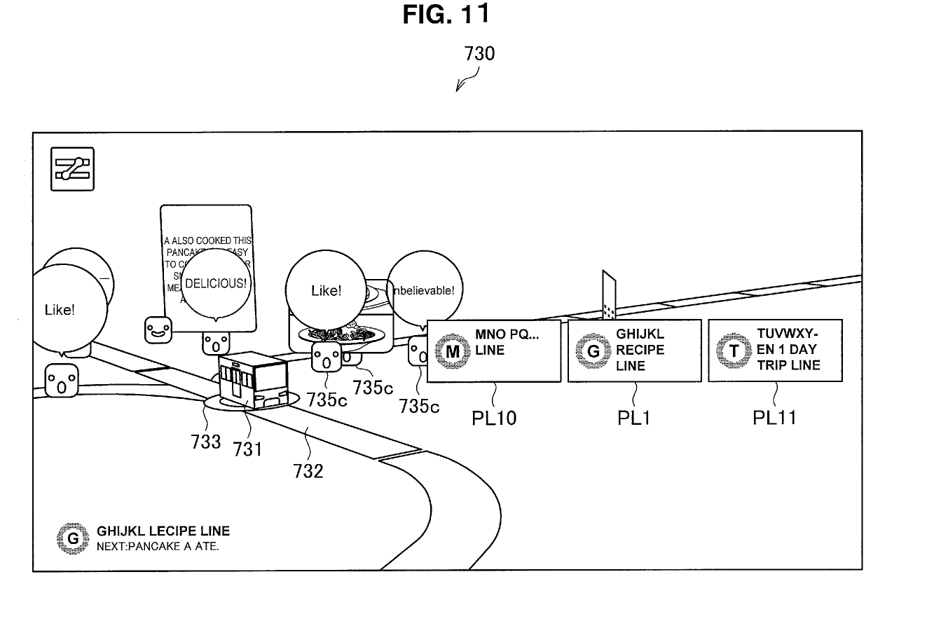

FIG. 11 is a diagram illustrating examples of virtual objects at the branch of the railroad track 732. The list reproduction unit 110 causes virtual objects to be displayed, the virtual objects indicating the degree of popularity of a playlist that can be switched at the branch of the railroad track 732, and impressions of persons who actually reproduced the playlist. Specifically, as illustrated in FIG. 11, the list reproduction unit 110 causes the first three virtual objects 735c of the virtual object information to be displayed at the branch position, the virtual object information being included in playlist data of each playlist being a branch destination.

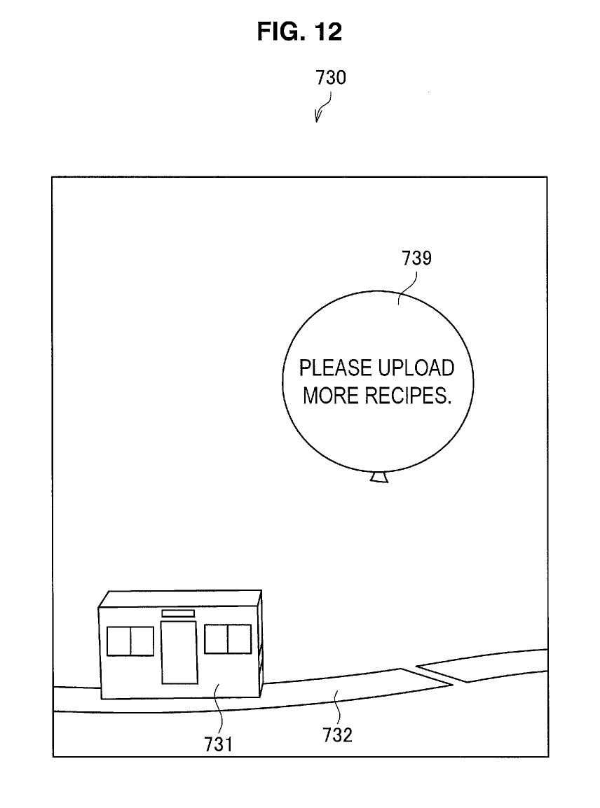

FIG. 12 is a diagram illustrating a display example of a comment about a playlist. The list reproduction unit 110 displays a comment about the playlist being reproduced. For example, as illustrated in FIG. 12, the list reproduction unit 110 causes a balloon 739 to be displayed so as to include comment text. Here, the list reproduction unit 110 changes the display position or the content of comment depending on the virtual object information.

In the present embodiment, the user can create and register a comment about a playlist while the playlist is being reproduced. The created comment is registered from the server 10.

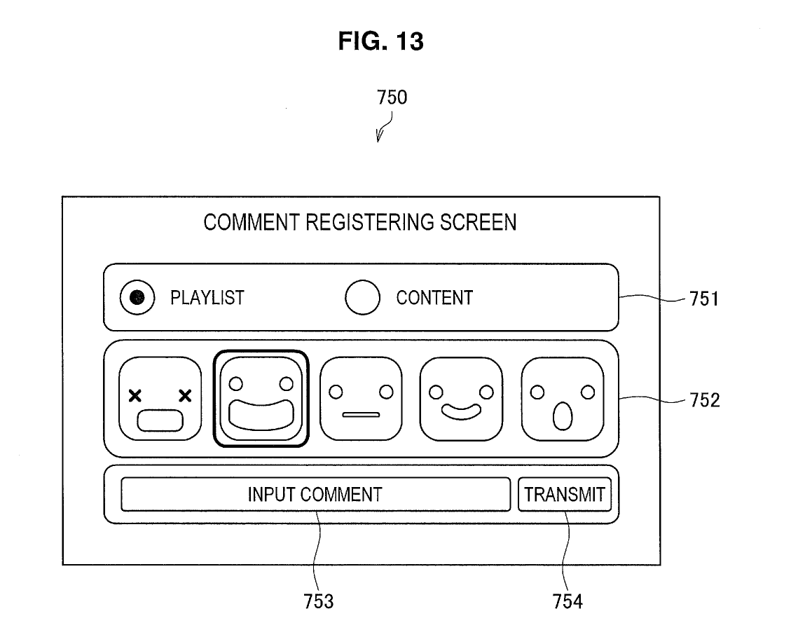

FIG. 13 is a diagram illustrating an example of a comment registering screen. The user can open a comment registering screen 750 illustrated in FIG. 13 by operating an operation unit or the like, while the playlist is being reproduced. The user can select a playlist or content in a target selection unit 751 on the comment registering screen 750, select an expression in an expression selection unit 752, and input a comment in a comment input unit 753. At a timing when the user presses a “TRANSMIT” button 754 on the comment registering screen, the information processing device 100 transmits a comment target (playlist or content), a target ID, a comment timing (second), an expression, and a content of comment, to the server 10. The comment registered in this manner is displayed later when another user reproduces the playlist.

### 3. Reproduction Processing of Playlist

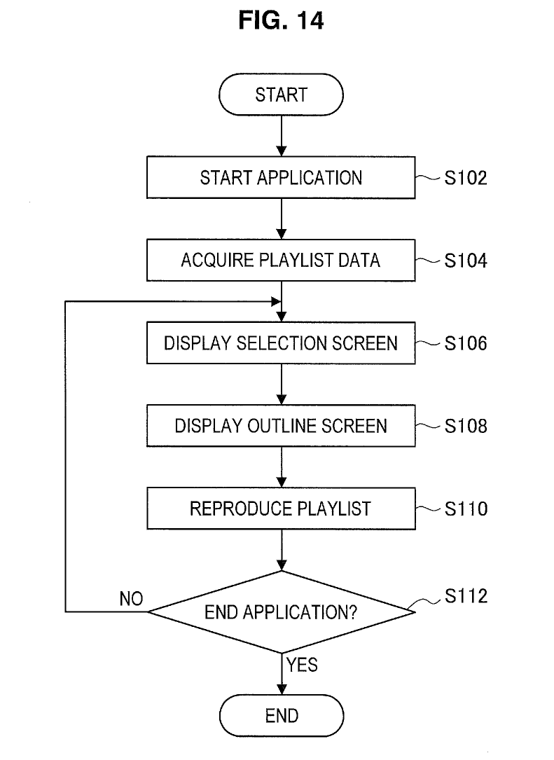

Reproduction processing of playlist according to an embodiment will be described with reference to FIG. 14.

Reproduction processing of playlist illustrated in FIG. 14 is achieved by a CPU of the information processing device 100 executing a program stored in a ROM.

Note that the program to be executed may be stored in a recording medium such as a CD (compact Disk), a DVD (digital versatile disk), or a memory card, or may be downloaded from a server, for example, on the Internet.

FIG. 14 is a flowchart illustrating reproduction processing of the playlist according to an embodiment. The flowchart in FIG. 14 is started when the information processing device 100 starts an application by a user operation for reproducing the playlist (step S102).

Next, the playlist acquisition unit 102 of the information processing device 100 acquires playlist data from the server 10 (step S104). This playlist data includes the list evaluation information for each playlist.

Next, on the basis of the acquired playlist data, the list display unit 104 causes the playlist selection screen 700 (FIG. 2) to be displayed (step S106). At this time, a virtual object is added to each playlist and displayed.

Next, when the user selects one playlist on the selection screen 700, before the reproduction of the selected playlist, the list selection unit 106 causes the outline screen 720 (FIG. 5) of the selected playlist to be displayed (step S108).

Next, the list reproduction unit 110 causes the selected playlist to be reproduced (step S110). That is, the list reproduction unit 110 switches from the outline screen 720 to the reproduction screen 730 (FIG. 6) to cause the selected playlist to be reproduced. At this time, the list reproduction unit 110 causes content items included in the playlist to be sequentially reproduced, and also adds a virtual object with respect to content being reproduced and causes the virtual object to be displayed.

After that, when the application is ended (step S112: Yes), this processing is completed. On the other hand, when the application is not ended (step S112: No) and the reproduction time of the playlist elapses, the reproduction screen 730 is switched to the selection screen 700 (step S106). Then, the user can select a playlist again on the selection screen 700.

### 4. Hardware Configuration

The above-described operation by the information processing device 100 is achieved by cooperation of a hardware configuration and software that are included in the information processing device 100. The hardware configuration of the information processing device 100 will be described below. Note that the device 10 has the same hardware configuration.

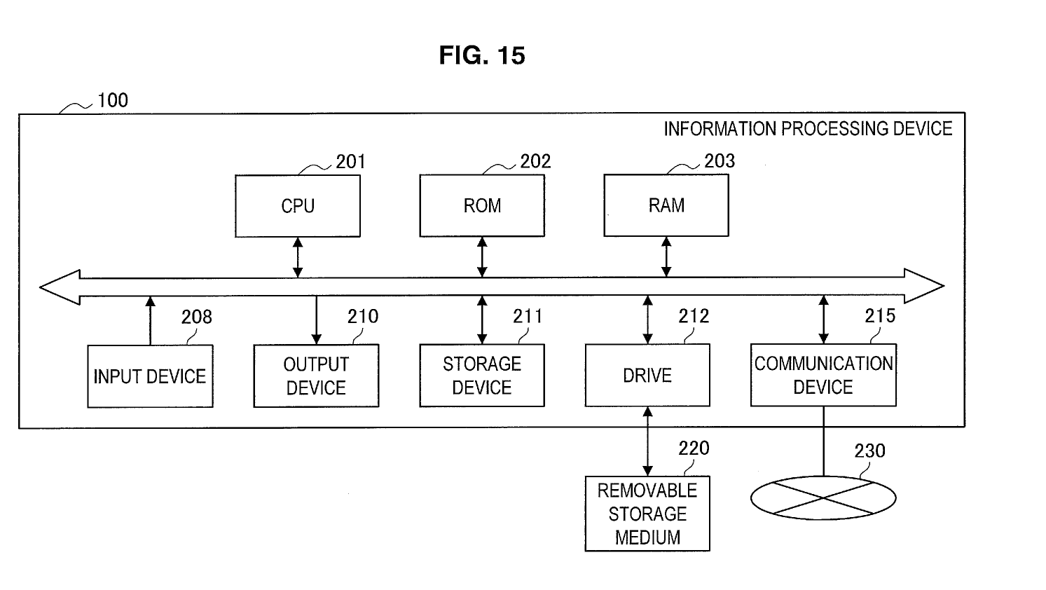

FIG. 15 is an explanatory diagram illustrating the hardware configuration of the information processing device 100. As illustrated in FIG. 15, the information processing device 100 includes a CPU (Central Processing Unit) 201, a ROM (Read Only Memory) 202, a RAM (Random Access Memory) 203, an input device 208, an output device 210, a storage device 211, a drive 212, and a communication device 215.

The CPU 201 serves as an operation processing device and a control device, and controls all the operations within the information processing device 100 in accordance with various programs. Further, the CPU 201 may be a microprocessor. The ROM 202 stores programs and operation parameters used by the CPU 201. The RAM 203 temporarily stores programs used in the execution of the CPU 201, and parameters that arbitrarily change in this execution. These units are mutually connected by a host bus constituted from a CPU bus or the like.

The input device 208 includes an input unit, such as a mouse, a keyboard, a touch panel, buttons, a microphone, switches, or leavers, for a user to input information, and an input control circuit that generates an input signal based on an input by the user, and outputs the input signal to the CPU 201. By operating this input device 208, it is possible for the user of the information processing device 100 to input various kinds of data for the information processing device 100 and to instruct the process operations.

The output device 210 includes, for example, a display device such as a liquid crystal display (LCD) device, an OLED (Organic Light Emitting Diode) device, or a lamp. In addition, the output device 210 includes a sound output device such as a speaker or headphones. For example, the display device displays a captured image or a generated image. On the other hand, the sound output device converts sound data or the like into sounds and outputs sounds.

The storage device 211 is a device for data storage constituted as an example of a storage unit of the information processing device 100 according to the present embodiment. The storage device 211 may include a storage medium, a recording device that records data to the storage medium, a reading device that reads data from the storage medium, and an erasure device that erases data recorded in the storage medium. This storage device 211 stores programs executed by the CPU 201 and various kinds of data.

The drive 212 is a reader/writer for the storage medium, and is built into the information processing device 100 or is externally attached. The drive 212 reads information recorded on a removable storage medium 220, such as a mounted magnetic disk, an optical disc, a magneto-optical disk, or a semiconductor memory, and outputs the information to the RAM 203. Further, the drive 212 can write information to the removable storage medium 220.

The communication device 215 is, for example, a communication interface constituted by a communication device or the like for connecting to a network 230. Further, the communication device 215 may be a communication device adaptive to wireless LAN (Local Area Network) or LTE (Long Term Evolution), or a wired communication device that communicates by wires.

The network 230 is a wired or wireless transmission path for information that is transmitted from devices connected to the network 230. For example, the network 230 may include a public line network such as the Internet, a telephone line network, or a satellite communication network, or various types of LANs (Local Area Networks) including the Ethernet (registered trademark), or WAN (Wide Area Network). The network 230 may include a leased line network such as IP-VPN (Internet Protocol-Virtual Private Network).

### 5. Conclusion

As illustrated in FIG. 2, on the selection screen 700 on which the playlist is selected, the above-described information processing device 100 adds the virtual objects (the virtual objects 716a illustrated in FIG. 3) based on the list evaluation information for each playlist, and causes the virtual objects to be displayed.

In this case, the user can visually grasp other people's evaluation of the playlist (including actions with respect to the playlist) by seeing the virtual objects 716a added to the playlist and displayed. Accordingly, the user can select a desired playlist easily by referring to the other people's evaluation.

In addition, in the above-described embodiment, one playlist includes a plurality of different kinds of content items (e.g., video, music, image, Web page, and book). Accordingly, the user can naturally experience a simulation involving a plurality of content items having a strong relevancy by reproducing one playlist. Specifically, it becomes possible to experience a series of experiences having a strong relevancy and continuity including reading the original book of a movie before watching the movie and buying a sound-track CD of the movie to listen to the music after watching the movie, by reproducing one playlist.

The preferred embodiments of the present disclosure have been described above in detail with reference to the accompanying drawings, whilst the technical scope of the present disclosure is not limited to the above examples. A person skilled in the art may find various alterations and modifications within the technical scope of the appended claims, and it should be understood that they will naturally come under the technical scope of the present disclosure.

The steps illustrated in the flowchart in the embodiment naturally include processes performed in the described and chronological order, and further include processes that are not necessarily performed in chronological order, but are also performed in parallel or are individually performed. Needless to say, it is also possible to change the order as necessary even in the steps for chronologically performing the processes.

The processing by the information processing device described herein may be realized by any one of software, hardware, and a combination of software and hardware. Programs included in the software are stored in advance, for example, in recording media provided inside or outside of the respective devices. Each program is read out, for example, by a random access memory (RAM) when each program is executed, and executed by a processor such as a CPU.

Additionally, the present technology may also be configured as below.

(1)

An information processing device including:

a playlist acquisition unit configured to acquire a plurality of playlists each including content, and list evaluation information for each playlist; and

a display control unit configured to cause a selection screen for selecting one playlist from among the acquired plurality of playlists to be displayed,

wherein, on the selection screen, the display control unit adds a virtual object based on the list evaluation information for each playlist and causes the virtual object to be displayed.

(2)

The information processing device according to (1),

wherein the display control unit causes the virtual object having a plurality of display modes to be displayed in accordance with the list evaluation information.

(3)

The information processing device according to (1) or (2),

wherein the playlist acquisition unit acquires a plurality of pieces of the list evaluation information for each playlist, and

wherein the display control unit adds, to each playlist, a plurality of the virtual objects on the basis of the plurality of pieces of the list evaluation information and causes the plurality of the virtual objects to be displayed.

(4)

The information processing device according to any one of (1) to (3),

wherein, when the one playlist is selected on the selection screen, the display control unit causes a display mode of the virtual object added to the one playlist to be changed.

(5)

The information processing device according to any one of (1) to (4),

wherein the plurality of playlists each include a plurality of different kinds of content items, and

wherein the information processing device further includes a reproduction unit configured to reproduce the one playlist when the one playlist is selected on the selection screen.

(6)

The information processing device according to (5), further including:

a content information acquisition unit configured to acquire content evaluation information of each of the content items of the one playlist to be reproduced,

wherein, when the one playlist is reproduced, the reproduction unit adds a virtual object based on the content evaluation information and causes the virtual object to be displayed.

(7)

The information processing device according to (6),

wherein, when the plurality of content items of the one playlist are sequentially reproduced, the reproduction unit adds a comment to a virtual object corresponding to content being reproduced, and causes the comment to be displayed.

(8)

The information processing device according to (6) or (7),

wherein the content information acquisition unit further acquires related content that relates to content to be reproduced and content evaluation information of the related content, and

wherein, when the one playlist is reproduced, the reproduction unit adds a virtual object based on the content evaluation information of the related content and causes the virtual object to be displayed.

(9)

The information processing device according to any one of (5) to (8),

wherein, when the one playlist is reproduced, the reproduction unit causes another playlist to be displayed in a selectable manner, and also adds a virtual object based on the list evaluation information of the other playlist and causes the virtual object to be displayed.

(10)

An information processing method including:

acquiring a plurality of playlists each including content, and list evaluation information for each playlist; and

adding, when a selection screen for selecting one playlist from among the acquired plurality of playlists is displayed, a virtual object based on the list evaluation information for each playlist and causing the virtual object to be displayed.

### REFERENCE SIGNS LIST

1 playlist reproduction system
10 server
100 information processing device
102 playlist acquisition unit
104 list display unit
106 list selection unit
108 content information acquisition unit
110 list reproduction unit
716a, 735 virtual object
PL playlist

1. An information processing device comprising:
a playlist acquisition unit configured to acquire a plurality of playlists each including content, and list evaluation information for each playlist; and
a display control unit configured to cause a selection screen for selecting one playlist from among the acquired plurality of playlists to be displayed,
wherein, on the selection screen, the display control unit adds a virtual object based on the list evaluation information for each playlist and causes the virtual object to be displayed.

2. The information processing device according to claim 1,
wherein the display control unit causes the virtual object having a plurality of display modes to be displayed in accordance with the list evaluation information.

3. The information processing device according to claim 1,
wherein the playlist acquisition unit acquires a plurality of pieces of the list evaluation information for each playlist, and
wherein the display control unit adds, to each playlist, a plurality of the virtual objects on the basis of the plurality of pieces of the list evaluation information and causes the plurality of the virtual objects to be displayed.

4. The information processing device according to claim 1,
wherein, when the one playlist is selected on the selection screen, the display control unit causes a display mode of the virtual object added to the one playlist to be changed.

5. The information processing device according to claim 1,
wherein the plurality of playlists each include a plurality of different kinds of content items, and
wherein the information processing device further includes a reproduction unit configured to reproduce the one playlist when the one playlist is selected on the selection screen.

6. The information processing device according to claim 5, further comprising:
a content information acquisition unit configured to acquire content evaluation information of each of the content items of the one playlist to be reproduced,
wherein, when the one playlist is reproduced, the reproduction unit adds a virtual object based on the content evaluation information and causes the virtual object to be displayed.

7. The information processing device according to claim 6,
wherein, when the plurality of content items of the one playlist are sequentially reproduced, the reproduction unit adds a comment to a virtual object corresponding to content being reproduced, and causes the comment to be displayed.

8. The information processing device according to claim 6,
wherein the content information acquisition unit further acquires related content that relates to content to be reproduced and content evaluation information of the related content, and
wherein, when the one playlist is reproduced, the reproduction unit adds a virtual object based on the content evaluation information of the related content and causes the virtual object to be displayed.

9. The information processing device according to claim 5,
wherein, when the one playlist is reproduced, the reproduction unit causes another playlist to be displayed in a selectable manner, and also adds a virtual object based on the list evaluation information of the other playlist and causes the virtual object to be displayed.

10. An information processing method comprising:
acquiring a plurality of playlists each including content, and list evaluation information for each playlist; and
adding, when a selection screen for selecting one playlist from among the acquired plurality of playlists is displayed, a virtual object based on the list evaluation information for each playlist and causing the virtual object to be displayed.
